(19) United States
(12) Patent Application Publication
(10) Pub. No.: US 2026/0201204 A1
(43) Pub. Date: Jul. 16, 2026

(54) BIOBASED SCOURING COMPOSITION AND ARTICLE

(71) Applicant: 3M INNOVATIVE PROPERTIES COMPANY, St. Paul, MN (US)

(72) Inventors: Stewart H. Corn, St. Paul, MN (US); Ignatius A. Kadoma, Cottage Grove, MN (US); Michael J. Wald, Woodbury, MN (US); Donald T. Landin, Eagan, MN (US); Alexander J. Bourque, St. Paul, MN (US); Patrick M. Crain, Stillwater, MN (US); Ann Marie Gilman, Bayport, MN (US); Kevin T. Reddy, Minneapolis, MN (US); Cory D. Sauer, Star Prairie, WI (US)

(21) Appl. No.: 19/135,570

(22) PCT Filed: Dec. 4, 2023
(86) PCT No.: PCT/IB2023/062211

§ 371 Date: Jun. 4, 2025

Related U.S. Application Data
(60) Provisional application No. 63/386,343, filed on Dec. 7, 2022.

(51) Int. Cl. C09D 167/04; A47L 13/16; C09D 7/63; C09D 167/02

(52) U.S. Cl. CPC C09D 167/04; A47L 13/16; C09D 7/63; C09D 167/02

(57) ABSTRACT

The present invention is a biobased homogeneous composition including a biobased polymer and a biobased wax, wherein the biobased wax comprises less than about 20% of the biobased homogenous composition. The biobased composition has a modulus of elasticity of at least about 0.5 GPa and a strain energy density of at least about 0.1 mJ/mm³.

### FIELD OF THE INVENTION

The present invention is related generally to the field of scouring articles. In particular, the present invention is a biobased scouring composition and article.

### BACKGROUND

Scouring pads are widely used to clean surfaces such as household surfaces, including those in the home as well as vehicular surfaces. The scouring pad is generally used with water and a soap or detergent, with a scouring surface of the scouring pad being used to clean a surface. Such surfaces include dishes, utensils, glasses, pots, pans, grills, walls, floors, countertops, and vehicular surfaces and windows.

Scouring materials are produced in many forms, including nonwoven webs (for example, the low-density nonwoven abrasive webs described in U.S. Pat. No. 2,958,593). Following manufacture, a web of scouring material may be cut into individual pieces of a size suitable for hand use (for example, the individual rectangular pads described in U.S. Pat. No. 2,958,593) or it may be left to the end user to divide the web into pieces of a convenient size when required (as described, for example, in WO 00/006341 and U.S. Pat. No. 5,712,210). Examples of non-scratch scouring pads are sold under the trade name “Scotch-Brite™” by 3M Company of Saint Paul, Minnesota.

Preferred nonwoven fibrous scouring materials are low density, open materials having a comparatively high void volume. Scouring materials of that type exhibit an effective cleaning action (because the voids retain material removed from a surface that is being cleaned) but are themselves easily cleaned simply by rinsing in water or some other cleansing liquid so that they can be re-used. Despite that, many scouring materials are intended for limited re-use only, following which they are discarded. From a hygiene standpoint, discarding such products before they become contaminated is to be recommended since they are frequently used for cleaning kitchen work surfaces as well as cooking and eating utensils. However, as consumers become increasingly concerned with environmental issues, they are increasingly reluctant to use disposable products unless they know that they can be recycled or will degrade quickly without producing harmful by-products. Thus, consumers are increasingly seeking out more sustainable products.

### BRIEF DESCRIPTION OF THE DRAWINGS

This disclosure may be more completely understood in consideration of the following detailed description of various embodiments of the disclosure in connection with the accompanying drawings, in which:

FIG. 1 is a cross-sectional view of a scouring article including a biobased homogeneous composition of the present invention.

FIG. 2 is a top view of a pattern used in the Examples of the present application.

While the above-identified figures set forth several embodiments of the disclosure, other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### SUMMARY

In one embodiment, the present invention is a biobased homogeneous composition including a biobased polymer and a biobased wax, wherein the biobased wax comprises less than about 20% of the biobased homogenous composition. The biobased composition has a modulus of elasticity of at least about 0.5 GPa and a strain energy density of at least about 0.1 mJ/mm³.

In another embodiment, the present invention is a scouring article including a nonwoven substrate and a biobased composition affixed onto the nonwoven substrate. The biobased composition includes a biobased polymer and a biobased wax, wherein the biobased wax comprises less than about 20% of the biobased composition. The biobased composition has a modulus of elasticity of at least about 0.5 GPa and a strain energy density of at least about 0.1 mJ/mm³ when measured according to ASTM D790-17. A composition of the nonwoven substrate is substantially different from the biobased composition.

### DETAILED DESCRIPTION

The present invention is a biobased homogeneous composition that can be incorporated into a scouring article. For example, the scouring article may be a wipe or a sponge. The biobased homogeneous composition generally includes a biobased polymer and a biobased wax. When included in a scouring article, the biobased homogeneous composition is affixed onto a first substrate to form a scouring layer that is then attached to a second substrate by an adhesive. In one embodiment, a scouring article including the biobased homogeneous composition is fully biobased, resulting in a sustainable product. The present invention enables many opportunities for environmentally sustainable aspects, such as by using environmentally sustainable raw materials. For example, in one embodiment, the scouring article is at least partially biodegradable, bio-based, recyclable, compostable, or made of recycled material. The scouring article of the present invention provides these benefits while maintaining sufficient scouring capabilities.

As used herein, a material is “degradable” when it is capable of degrading as a result of exposure to the environmental effects of sunlight, heat, water, oxygen, pollutants, microorganisms, insects and/or animals. Usually such materials are naturally occurring and are usually “biodegradable”. As used herein, “biodegradable” materials are those which are degraded by microorganisms or by enzymes and the like produced by such microorganisms. As used herein, “biodegradable” refers to materials or products that meet the requirements of ASTM D6400-12 (2012), which is the standard used to establish whether materials or products satisfy the requirements for labeling as “compostable in municipal and industrial composting facilities.”

As used herein, a material is “compostable” when it is capable of breaking down into natural elements in a compost environment. As used herein, “compostable” refers to materials that undergo degradation by biological processes during composting to yield carbon dioxide, water, inorganic compounds, and biomass at a rate consistent with other compostable materials and leaves no visible, distinguishable or toxic residue. As used herein, “biodegradable” refers to materials or products that meet the requirements of ASTM D6400.

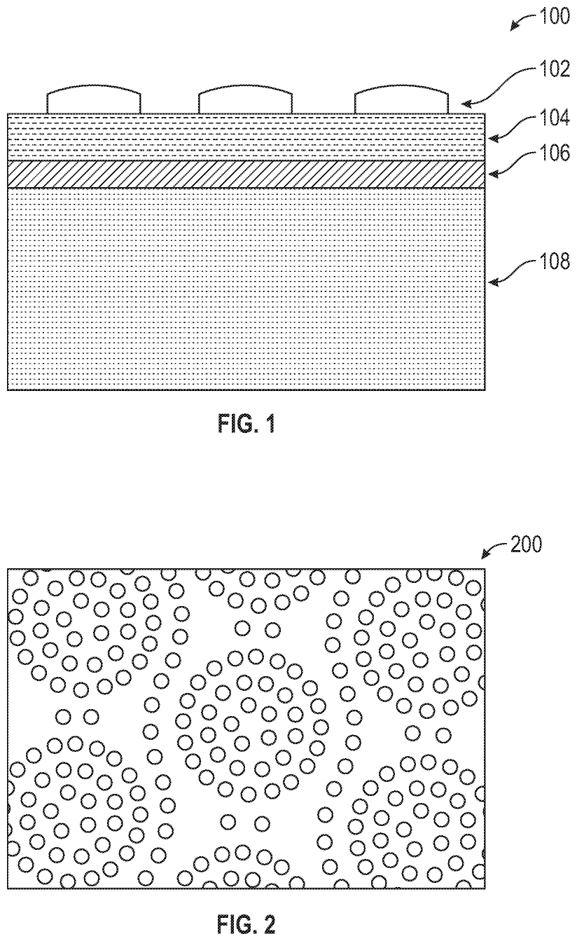

FIG. 1 shows a cross-sectional view of the scouring article 100 of the present invention. The scouring article 100 may take any shape without departing from the intended scope of the present invention. The scouring article 100 generally includes a scouring layer 102 including the biobased homogeneous composition deposited on the first substrate 104. The scouring layer 102 is then attached to a second substrate 108 by an adhesive 106.

The biobased homogeneous composition generally includes a biobased polymer and a biobased wax. The biobased polymer is the primary component of the biobased homogeneous composition and must have good adhesion to the first substrate as well as a minimum hardness to effectively scour. In one embodiment, the biobased polymer has a Shore D durometer of at least about 50 when measured according to ASTM D2240-15. At a Shore D of less than about 50, the biobased polymer may be too soft to effectively scour and can be easily indented. Thus, rather than removing adherend particles from a surface to be cleaned, the biobased homogeneous composition may deform. This can result in decreased scouring and durability of the biobased homogeneous composition. Examples of suitable biobased polymers include, but are not limited to: polylactic acid, polybutylene succinate, polybutylene adipate terephthalate, and mixtures thereof.

The biobased wax functions to increase lubricity and maintain the viscosity of the biobased homogenous composition. The biobased wax comprises less than about 20% of the biobased homogenous composition, and particularly less than about 10% of the biobased homogenous composition. If the amount of biobased wax in the biobased homogenous composition is too high, it may result in segregation of the wax, causing the biobased homogenous composition to become soft and lower the scouring efficiency of the biobased homogeneous composition. If the amount of biobased wax in the biobased homogenous composition is too low, then the biobased homogeneous composition may not melt and flow easily, making it difficult to deposit onto the first substrate. It is important that the melting point of the biobased wax is above the use temperature so that it does not melt when in use. In one embodiment, the biobased wax has a melting point of at least about 50° C. and particularly of at least about 60° C. In one embodiment, the biobased wax is hydrogenated. Examples of suitable biobased waxes include, but are not limited to: soybean oil, castor oil, and ethylene bis-stearamide. Particularly suitable examples include hydrogenated castor oil and hydrogenated soybean oil glycerides.

The entirety of the biobased homogeneous composition is uniform throughout, as opposed to being a fluid with suspended particles. The biobased homogeneous composition has a modulus of elasticity of at least about 0.5 GPa, and a strain energy density of at least about 0.1 mJ/mm³. The modulus of elasticity is a measurement of the stiffness of a material and the strain energy density is the potential energy that is stored in a material when it is deformed. The strain energy density is defined as the area under the stress-strain curve where stress and strain are performed according to ASTM D790-17, and calculated using equations 3 and 5, respectively. The modulus of elasticity is calculated using equation 6 in ASTM D790-17.

The biobased homogeneous composition has a wet coefficient of friction of about 0.50 or less, particularly of about 0.45 or less, and more particularly of about 0.40 or less. If the wet coefficient of friction is too high, the biobased homogeneous composition will not smoothly glide over the surface to be cleaned, but instead will “grab” the surface to be cleaned, even when it isn't soiled. The biobased homogeneous composition has a percent crystallinity of about 50% or less, particularly of about 40% or less, and more particularly of about 35% or less. The crystallinity of the biobased homogeneous composition can impact processing, particularly hot melt processing. The crystallinity should be low to help avoid formation of “gel” particles in the cool spots of the printing equipment.

The biobased homogeneous composition is applied to the surface of the first substrate while melted, and therefore must be within a certain viscosity range at temperatures commonly used for hot melt coating. The complex viscosity of the biobased homogeneous composition at 100° C. is at least about 5×10¹ Pa·s and at 175° C. is less than about 1×10⁵ Pa·s, particularly at 100° C. is at least about 1×10² Pa·s and at 175° C. is less than about 5×10⁴ Pa·s, and more particularly at 100° C. is at least about 1×10³ Pa·s and at 175° C. is less than about 1×10⁴ Pa·s. In one embodiment, the biobased homogeneous composition is substantially free of tackifier.

The biobased homogeneous composition can be incorporated into a scouring article as part of a scouring layer. The scouring/texture layer of the present invention is not brittle and is sufficiently hard in warm, soapy water such that is resists deformation under hand pressure while still being melt processable. When the biobased homogeneous composition is incorporated into a scouring article, the biobased homogeneous composition is affixed onto a first substrate, forming the scouring layer. The scouring layer must have reasonably good durability and allow the scouring article to glide along a variety of types of surfaces. The scouring layer must also be able to adhere to the first substrate. The first substrate must have reasonably good cohesive strength in the thickness direction so that the scouring layer does not prematurely disintegrate.

The first substrate has a basis weight of between about 50 gsm and about 500 gsm. If the first substrate has a basis weight of less than about 50, unsightly adhesive saturation may be observed through the first substrate to the top surface of the scouring article. If the first substrate has a basis weight of greater than about 500 gsm, it may be too stiff and inflexible to conform well when used in practice for cleaning a surface. In one embodiment, the first substrate is biobased. In one embodiment, the first substrate is fibrous. A fibrous substrate can be beneficial for conformability/flexibility and to allow water to flow through the construction. The first substrate may or may not participate in scouring action of the scouring article. In one embodiment, the first substrate is a nonwoven or a bicomponent nonwoven. In one embodiment, the first substrate is a spunbonded bicomponent nonwoven including a core and sheath. The sheath has a sufficiently low melting point to enable good cohesive strength (i.e., good z-direction strength), but is not so low as to melt and become stiff when the biobased homogeneous composition is affixed onto the first substrate, for example, when the biobased homogeneous composition is hot melt screen printed onto the first substrate. The core and sheath may be formed of the same or different compositions and have a ratio of between about 70/30 core/sheath and about 50/50 core/sheath. Examples of the first substrate include, but are not limited, to various grades of: polylactic acid and polybutylsuccinate. However, the first substrate must have a different composition than the biobased homogeneous composition. The composition difference helps to prevent melting of the first substrate when the biobased homogeneous composition is affixed to the first substrate.

The biobased homogeneous composition can be affixed onto the first substrate as a patterned layer that has texture, aiding in scouring. In some embodiments, the patterned layer has a pattern, such as pattern 200 of FIG. 2. The biobased homogeneous composition can be affixed on the first layer in a plurality of discrete segments. The discrete segments may form a pattern or may be positioned randomly on the surface of the first substrate. In one embodiment, the discrete segments are a plurality of dots. In one embodiment, the dots have a height of between about 0.1 and about 5 mm, particularly between about 0.2 and about 2.5 mm, and more particularly between about 0.3 and about 1.5 mm. In another embodiment, the scouring layer is affixed as a thin layer along the entire surface of the first substrate. The biobased homogeneous composition can be affixed to the first substrate by any means known to those of skill in the art, such as, without limitation, by spraying or screen printing. In one embodiment, the biobased composition is affixed onto the first substrate by a melt coating process, such as hot melt screen printing, hot melt gravure roll coating, or spraying. In one embodiment, when the biobased homogeneous composition is screen printed, the biobased homogeneous composition covers between about 1 and about 100% of the surface of the first substrate, particularly between about 10 and about 30% of the surface of the first substrate, and more particularly between about 15 and about 20% of the surface of the first substrate. In one embodiment when the biobased homogeneous composition is sprayed, the biobased homogeneous composition covers up to about 80%, particularly up to about 90%, and more particularly up to about 100% of the surface of the first substrate.

While the biobased homogeneous composition is fully biobased, the biobased homogeneous composition is still effective at scouring when used as part of a scouring layer.

The scouring layer including the first substrate and the biobased homogeneous composition may optionally be affixed to a second substrate. The second substrate can provide a better grip to the user and can also provide a second surface for which the scouring article can be used to clean a surface. Examples of the second substrate can include, but are not limited to, a cellulose or foam sponge or a nonwoven. In one embodiment, the second substrate is biobased.

When the scouring article includes a second substrate, the scouring layer is attached to the second substrate by an adhesive. The adhesive must allow flexibility of each of the layers for good conformability. The adhesive must also not delaminate in warm water. In one embodiment, the adhesive is biobased. In one embodiment, the adhesive may include, but is not limited to polyamides. To adhere the scouring layer onto the second substrate, the adhesive is first sprayed, roll coated, or extruded onto one surface of the second substrate, and then the scouring layer is placed on the surface of the second substrate with the adhesive.

The scouring article of the present invention is biodegradable. One measure of biodegradability is disintegration. Disintegration can be measured according to ISO 20200 under thermophilic aerobic composting conditions or ISO 16929 with a minimum vessel volume of 35 L. In one embodiment, the scouring article has a degree of disintegration of at least about 50% after 8 weeks when measured according to a modified ISO 20200:2015 (testing for 8 weeks, rather than 12 weeks). Compostability can be measured according to ISO 20200 in which a plastic product is considered to have demonstrated satisfactory disintegration if after twelve weeks in a controlled composting test, no more than 10% of its original dry weight remains after sieving on a 2.0 mm sieve. Biodegradation can also be measured with an additional CO₂ measurement according to other test methods as listed in section 6.3 of ISO-20200.

Other materials can be added to the scouring article for special purposes, including, but not limited to: grinding aids, lubricants, wetting agents, surfactants, pigments, dyes, colorants, fillers, fragrances, coupling agents, plasticizers, mild abrasives, abrasive materials, cross-linkers, antistatic agents, antioxidants, particles, and suspending agents. The materials can be added for functional purposes or aesthetic purposes. For example, dyes, colorants, fragrances and particles can serve aesthetic purposes. Examples of suitable abrasive materials include, but are not limited to: crushed walnut shells, peach pits, rice hulls, and the like. Other suitable abrasive materials are inorganic, such as, for example, iron oxide-based pigment. In one embodiment, the additives are composed of a sustainable material. That is, the additive may be biodegradable, bio-based, recyclable, compostable, or made of recycled material.

### Examples

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

TABLE 1
Materials

| Trade name | Abbreviation | Material description | Source/Supplier |
|---|---|---|---|
| ECOVIO F2341 | ECOVIO | Modified polyester | BASF Canada, Inc., |
| | | resin | Mississauga, ON, |
| | | | CANADA |
| ECOFLEX BATCH | ECOFLEX | Modified polyester | BASF Corporation, |
| AB1 | | resin | Florham Park, NJ, USA |
| INGEO | PLA 4060D | Polylactic acid resin | Natureworks, LLC, |
| BIOPOLYMER | | | Minnetonka, MN, USA |
| 4060D | | | |
| INGEO | PLA 6100D | Polylactic acid resin | Natureworks, LLC |
| BIOPOLYMER | | | |
| 6100D | | | |
| INGEO | PLA 6202D | Polylactic acid resin | Natureworks, LLC |
| BIOPOLYMER | | | |
| 6202D | | | |
| INGEO | PLA 6252D | Polylactic acid resin | Natureworks, LLC |
| BIOPOLYMER | | | |
| 6252D | | | |
| INGEO | PLA 6302D | Polylactic acid resin | Natureworks, LLC |
| BIOPOLYMER | | | |
| 6302D | | | |
| INGEO | PLA 6361D | Polylactic acid resin | Natureworks, LLC |
| BIOPOLYMER | | | |
| 6361D | | | |
| BIO PBS FZ71 | PBS FZ71 | Polybutylene | PTT MCC Biochem Co., |
| | | succinate resin | Ltd., Bangkok, Thailand |
| HJ-2000 | HJ-2000 | Polyamide hot melt | Shandong Huijin Chemical |
| | | adhesive | Co., Ltd., Dongying City, |
| | | | Shandong Province, China |
| HALLGREEN | R8010 | Renewable polymeric | Hallstar, Chicago, IL, |
| R8010 | | ester plasticizer | USA |
| CITRIC ACID | Citric acid | Anhydrous citric acid | Cargill Acidulants, |
| | | | Eddyville, IA, USA |
| HUBERCARB Q325 | CaCO₃ | Calcium carbonate | Huber Engineered |
| | | | Materials, Atlanta, GA, |
| | | | USA |
| NATUREWAX S- | S-113 | Hydrogenated | Cargill Industrial |
| 113 | | soybean glycerides | Specialties, Plymouth, |
| | | | MN, USA |
| NATUREWAX ST- | ST-130 | Hydrogenated | Cargill Industrial |
| 130 | | soybean glycerides | Specialties |
| NATUREWAX S- | S-155 | Hydrogenated | Cargill Industrial |
| 155 | | soybean glycerides | Specialties |
| CASTOR WAX MP- | MP-80 | Hydrogenated castor | Vertellus Performance |
| 80 | | oil | Materials, Greensboro, |
| | | | NC, USA |
| CRODAMIDE EBS | EBS | Ethylene bis- | Croda Polymer Additives, |
| | | stearamide | Goole, East Yorkshire, UK |
| PLA 033.000:1 | Yellow | Yellow masterbatch | Clariant Corp., Holden, |
| YELLOW CANARY | masterbatch | blend with PLA | MA, USA |
| PLA 033.000:1 | Brown | Brown masterbatch | Clariant Corp. |
| LIGHT BROWN | masterbatch | blend with PLA | |
| PLA 4032D | White | White masterbatch | Clariant Corp. |
| 033.000:1 WHITE | masterbatch | blend with PLA | |
| 40% | | | |
| TECHNOMELT | Technomelt | Polyamide hotmelt | Henkel Corporation, |
| 6240 | 6240 | adhesive | Rocky Hill, CT, USA |
| 3M HOTMELT | 3M 3789 | Polyamide hotmelt | 3M Company, St. Paul, |
| ADHESIVE 3789 | | adhesive | MN, USA |
| HY288 | HY288 | Polyamide hotmelt | Anqing Hongyu Chemical |
| | | adhesive | Co., Ltd., Anqing, Anhui |
| | | | Province, China |
| 3M CELLULOSE | 3M cellulose | Cellulose sponge | 3M Company, St. Paul, |
| | sponge | | Minnesota |
| 3M SCRUB DOTS | 3M Scrub | Cellulose scrub | 3M Company |
| | Dots | sponge | |
| N250 SPONGE | N250 sponge | dry sponge cloth | Kalle GmbH, Wiesbaden, |
| CLOTH | cloth | approximately 250 | Germany |
| | | g/m2 and 1.5 mm | |
| | | thick | |

### Examples

### Substrates

Four substrates were prepared following the general method disclosed in U.S. Pat. No. 3,802,817 (Matsuki et al). The fiber-forming material was melted in an extruder and pumped into extrusion heads that included multiple orifices arranged in a regular pattern, e.g., straight line rows. Filaments of fiber-forming liquid were extruded from the extrusion head and conveyed through air-filled space to an attenuator. Filaments were in a core/sheath configuration. This configuration persists even if the core and sheath are made of the same material, as a boundary exists between the two layers (core and sheath) of the material. Quenching streams of air were directed toward extruded filaments; the air may reduce the temperature of, or partially solidify, the extruded filaments.

The filaments passed through the attenuator and then were deposited onto a generally flat collector surface where they were collected as a mass of fibers or web.

The collector was generally porous, and a gas-withdrawal (vacuum) device was positioned below the collector to assist deposition of fibers onto the collector (porosity, e.g., relatively small-scale porosity, of the collector does not change the fact that the collector was generally flat as defined above).

Sheath/core filaments were extruded at a temperature of 200° C. to 230° C., then drawn by quench air at 10° C. and an air volume flowrate of 23 m³/min to form a nonwoven web. Web speed was adjusted as needed to obtain the desired basis weight. Web basis weights were obtained between 45 and 150 grams per square meter (gsm). When the core and sheath were of different compositions, i.e. bicomponent, the ratio of core to sheath was approximately 50/50 or 70/30, as indicated below.

### Substrate 1:

A spun bonded nonwoven of PLA 6102D in core and sheath at 45 gsm.

### Substrate 2:

A spun bonded PLA 6202D nonwoven at 100, 125, and 150 gsm, with 2% pigment concentrate (made from a mixture of 2:1 brown master batch to white master batch), calendared between two hot rolls at 104° C., 3 meters/minute (m/min) and 90,000 N/m nip pressure. One of the calendar rolls was smooth, the other had a pattern contacting 17% of the treated area.

### Substrate 3:

A spun bonded bicomponent nonwoven with a PLA 6202D core and a PBS FZ71 sheath (PTT MCC Biochem Company, Thailand), in approximately a 70/30 core/sheath ratio, at 100 gsm and calendared as described above for substrate 2.

### Substrate 4:

A spun bonded bicomponent nonwoven with a PLA 6100D core and a PLA 6302D sheath, in approximately a 70/30 core/sheath ratio, at 100 gsm, spun bonded and calendared as above for substrate 2.

### Biobased Compositions

### Examples 1-16 (EX1-EX16) and Comparative Examples 1-10 (CE1-CE10)

Examples 1-6 and Comparative Examples 2-6 were compounded on a Coperion (Stuttgart, Germany) 18 mm co-rotating twin screw extruder operated at between 160° C. and 195° C. and between 7 and 14 kg/hr. Examples 10-21 were compounded on a Berstorff 25 mm co-rotating twin screw extruder operated at between 190° C. and 220° C. and at 7.5 kg/hr. Selected compositions were then printed on the substrates described above using a custom-built hot melt screen printer (Telstar Engineering, Burnsville MN USA), except Comparative Example 1 which was used as provided from the supplier and printed by hand as described below. Comparative Examples 8-14 and Examples 7-12 were not printed. Printing temperatures and web speeds were varied to create the best appearing dots. Typically, hot melt printing temperatures were 160° C.-190° C., and web speeds were 3 to 30 m/min unless otherwise noted. If noted, circular dots, typically 1.5 to 2.0 mm in diameter, with height from about 0.3 to 2.0 mm were printed with the compositions on a substrate.

### Comparative Example 1 (CE1)

HJ-2000 was used as received. An array of flat-topped dots spaced 5 mm apart were created on Substrate 1 by melting the HJ-2000 composition over the substrate while using a perforated metal plate as a stencil. Excess was scraped off with a heated putty knife before peeling away the stencil.

### Example 1 (EX1)

A 60/40 blend of HJ-2000 and CaCO₃ was compounded, then printed on Substrate 2 in a pattern of dots 200 as represented in FIG. 2.

### Comparative Example 2 (CE2)

A blend of 95% PLA 4060D/PLA 6252D/R8010/citric acid/CaCO₃ (in a ratio of 30/50/10/2/8) and 5% yellow masterbatch was compounded, then printed on Substrate 2 in a pattern of dots as represented in FIG. 2.

### Example 2 (EX2)

A blend of PLA 6252D/HJ2000/MP-80/CaCO₃ was compounded in a ratio of 60/10/10/20. This composition required temperatures as high as 190° C. and line speeds of up to 45 m/min during printing on Substrate 2 as represented in FIG. 2.

### Example 3 (EX3) and Example 4 (EX4)

A blend of PBS FZ71 and MP-80 was compounded in a ratio of 90/10, then printed onto Substrates 2 and 3 to form EX3 and EX4, respectively, in a pattern of dots as represented in FIG. 2.

### Comparative Example 3 (CE3) and Comparative Example 4 (CE4)

A blend of PBS FZ71/MP-80/citric acid was compounded in a 70/28/2 ratio, then printed on Substrates 2 and 3 to form CE3 and CE4, respectively, in a pattern of dots as represented in FIG. 2.

### Example 5 (EX5) and Example 6 (EX6)

A blend of PBS FZ71/MP-80/citric acid was compounded in an 80/18/2 ratio, then printed on Substrates 2 and 3 to form EX5 and EX6, respectively, in a pattern of dots as represented in FIG. 2.

### Example 7 (EX7)

A blend of PLA 6361/MP-80 was compounded in a 90/10 ratio, then printed on Substrate 4 in a pattern of dots as represented in FIG. 2.

### Example 8 (EX8)

A blend of PLA 6361/MP-80 was compounded in a 95/5 ratio, then printed on Substrate 4 in a pattern of dots as represented in FIG. 2.

### Example 9 (EX9)

PLA 6361 (100%) was used as a control without a printed array or pattern of dots.

### Example 10 (EX10)

A blend of 94.5 weight % PLA 6361, 5 weight % ethylene bis(stearamide) wax and 0.5 weight % brown masterbatch was compounded, then printed on Substrate 4 in an array of dots. An array of dots spaced 5 mm apart was printed using the hot melt screen printer described above.

### Examples 11-16 (EX11-EX16) and Comparative Examples 5-10 (CE5-CE10)

Ecovio or Ecoflex polyester resins were blended with soy waxes per the compositions defined in Table 2.

TABLE 2
Compositions

| ID | Polymer | Wax | Poly/wax |
|---|---|---|---|
| CE5 | Ecoflex AB1 | S-155 | 90/10 |
| CE6 | Ecoflex AB1 | S-155 | 95/5 |
| CE7 | Ecoflex AB1 | ST-130 | 90/10 |
| CE8 | Ecoflex AB1 | ST-130 | 95/5 |
| CE9 | Ecoflex AB1 | S-113 | 90/10 |
| CE10 | Ecoflex AB1 | S-113 | 95/5 |
| EX11 | Ecovio F2341 | S-155 | 90/10 |
| EX12 | Ecovio F2341 | S-155 | 95/5 |
| EX13 | Ecovio F2341 | ST-130 | 90/10 |
| EX14 | Ecovio F2341 | ST-130 | 95/5 |
| EX15 | Ecovio F2341 | S-113 | 90/10 |
| EX16 | Ecovio F2341 | S-113 | 95/5 |

### Scrubbing Articles

### Examples 17-21 (EX17-21) and Comparative Example 11 (CE11)

Various adhesives were applied to one side of cellulose sponges of different thicknesses by extruding or roll coating the adhesives in the melt state, then the unprinted side of the printed substrates was brought into contact with the adhesive-coated cellulose and pressure was applied, either by hand or by nipping between rubber rollers, to make laminated scrub sponge constructions. Alternatively, the adhesives were first applied to the unprinted side of a printed substrate, then the adhesive coated side was brought into contact with cellulose sponge and pressure was applied to make laminated constructions.

### Comparative Example 11 (CE11)

Technomelt 6240 adhesive was extruded onto cellulose sponge and sponge cloths of various thicknesses using a Coperion ZSX18 co-rotating twin screw extruder operated at about 250° C. to deliver a coating weight of 80 g/m², then laminated by nipping to Substrate 2 previously printed with the composition described in Comparative Examples 3 and 4.

### Example 17 (EX17)

Technomelt 6240 adhesive was extruded onto cellulose sponge and sponge cloths of various thicknesses using a Coperion ZSX18 co-rotating twin screw extruder operated at about 250° C. to deliver a coating weight of 80 g/m², then laminated by nipping to Substrate 3 previously printed with the composition described in Examples 5 and 6.

### Example 18 (EX18)

HY288 was extruded onto Substrate 4 previously printed with the composition described in Example 7, using a Coperion ZSX18 co-rotating twin screw extruder operated at about 110° C. to deliver a coating weight of 150 g/m². The coated substrate was immediately nipped to sponge and sponge cloths of various thicknesses, both dry and damp.

### Example 19 (EX19)

HY288 was applied to Substrate 4 previously printed with the composition described in Example 7 using a Coperion ZSX18 co-rotating twin screw extruder operated at about 115° C. to deliver a coating weight of 215 g/m². The coated substrate was immediately nipped to sponge and sponge cloths of various thicknesses, both dry and damp.

### Example 20 (EX20)

HY288 was roll coated onto 15 mm thick cellulose and sponge cloth using a Model 775 hotmelt SPR S/T laminator (Black Bros. Co., Mendota IL USA) with an adhesive temperature of about 180° C. Then Substrate 4, previously printed with the composition described in Example 7, was applied to the coated cellulose and held under pressure until the adhesive hardened. Coating weights were between 172 g/m² and 366 g/m².

### Example 21 (EX21)

3M adhesive 3789 was roll coated onto 15 mm thick cellulose using a Model 775 hotmelt SPR S/T laminator (Black Bros. Co., Mendota IL USA) with an adhesive temperature of about 180° C. Then Substrate 4, previously printed with the composition described in Example 7, was applied to the coated cellulose and held under pressure until the adhesive hardened. Coating weights were between 172 g/m² and 366 g/m².

### Test methods

### In-Sink Test:

A sink was filled with between 2 and 6 liters of tap water at 45C, and approximately 3g liquid dish detergent (Dawn, P&G, Cincinnati, Ohio, USA) was added. A scrub sponge construction was used to wash lightly soiled ceramic and/or plastic tableware for a total of approximately 5-10 minutes, then the scrub sponge was rinsed in warm water and visually inspected for substrate wear, dot loss, and delamination between the printed substrate and cellulose sponge. The scrub sponge was allowed to air dry, then the test was repeated several times or until failure was observed.

The in-sink test revealed that the adhesive became soft in warm water for Comparative Example 11 and Example 17, which allowed the printed substrate and cellulose to separate. For Examples 18 and 21, the adhesive delaminated after between 1-6 uses. For Examples 19 and 20, the adhesive adhered well and did not show any delamination when used several times in an in-sink test, except for the lowest adhesive application level on Example 20, which delaminated upon the first use.

### Hardness, Friction and 3-Point Bend Tests:

Samples were melted in a Blue M gravity convention laboratory oven (Thermal Product Solutions, White Deer PA, USA) at temperatures of 275F-375F then poured into aluminum pans or silicone molds to make flat sheets, slabs or wafers between 1.5 mm and 1 cm thick, depending on the requirements of the hardness, friction, and 3-point bend tests described below.

### Hardness Test:

Durometer hardness was conducted on 0.5-1 cm thick pieces of each dot composition using a Shore D gauge following the method of ASTM D2240-15.

### Wet Dynamic Coefficient of Friction:

Wet dynamic coefficient of friction (WDCOF) was measured on flat sheets between 1.5 and 4 mm thick following the method of ANSI B101.3-2012, using a BOT3000E Digital Tribometer (Regan Scientific Instruments) fitted with a styrene butadiene rubber sensor, taking 4 scans per sample and 4 readings per scan. Dry static COF was performed per the instrument manufacturer's instructions, without any liquid on the surfaces. Shore D hardness and coefficient of friction results are in Table 3.

TABLE 3
Hardness and CoF Results

| | Type D | | | |
|---|---|---|---|---|
| | durometer | Dry static COF | WDCOF | Substrate |
| CE1 | 48 | 0.91 | 0.36 | 1 |
| EX1 | 52 | 0.92 | 0.59 | 2 |
| CE2 | 33-54 | 0.63 | 0.37 | 2 |
| EX2 | 61 | ND | ND | 2 |
| EX3 | 57 | 0.46 | 0.33 | 2 |
| EX4 | | | | 3 |
| CE3 | 19-49 | 0.36 | 0.26 | 2 |
| CE4 | | | | 3 |
| EX5 | ND | 0.50 | 0.21 | 2 |
| EX6 | | | | 3 |
| EX7 | 75 | 0.52 | 0.26 | 4 |
| EX8 | 67 | ND | ND | 4 |
| EX9 | 77 | ND | ND | None |
| EX10 | 81 | ND | ND | 4 |
| CE5 | 39 | ND | ND | None |
| CE6 | 41 | ND | ND | None |
| CE7 | 39 | ND | ND | None |
| CE8 | 40 | ND | ND | None |
| CE9 | 34 | ND | ND | None |
| CE10 | 35 | ND | ND | None |
| EX11 | 59 | ND | ND | None |
| EX12 | 59 | ND | ND | None |
| EX13 | 61 | ND | ND | None |
| EX14 | 60 | ND | ND | None |
| EX15 | 48 | ND | ND | None |
| EX16 | 56 | ND | ND | None |

ND = Not Determined

A range was given for durometer readings on Comparative Examples 2, 3, and 4 because the samples frequently broke apart during durometer testing.

### Three-Point Bend Test:

Mean strain at failure, strain energy density, and modulus of elasticity were evaluated on wafers with dimensions approximately 15 cm×21 mm×3.5 mm using a 3-point bend test, based on ASTM D790-17. Strain energy density was calculated as the area under the stress strain curve from zero strain to specimen failure or to a strain of 2%, whichever came first. In cases where the specimen did not fail, the strain at failure and strain energy density could not be determined; however, the strain and strain energy density at the end of the test were calculated and used as a lower bound for the failure properties (and are indicated by >). Modulus was calculated from the tangent modulus of elasticity in ASTM D790-17, section 12.5.1, equation 6, as the slope of the tangent to the initial straight-line portion of the load-deflection curve.

TABLE 4
Summary of Mean Strain at Failure, Strain Energy
Density at Failure or 0.02 strain, and Modulus

| | | Strain Energy Density | |
|---|---|---|---|
| | Strain at Failure (—) | (mJ/mm³) | Modulus (GPa) |
| CE1 | >0.058 | >0.06 | 0.29 |
| EX1 | 0.031 | 0.10 | 0.51 |
| CE2 | 0.004 | 0.004 | 0.64 |
| EX3 | >0.044 | >0.12 | 0.62 |
| EX4 | | | |
| CE3 | 0.006 | 0.01 | 0.76 |
| CE4 | | | |
| EX7 | 0.019 | 0.41 | 2.56 |
| EX9 | 0.029 | 0.69 | 3.57 |
| CE5 | >0.093 | >0.02 | 0.11 |
| CE6 | >0.079 | >0.02 | 0.10 |
| CE7 | >0.094 | >0.02 | 0.08 |
| CE8 | >0.081 | >0.02 | 0.09 |
| CE9 | >0.088 | >0.02 | 0.08 |
| CE10 | >0.090 | >0.01 | 0.07 |
| EX11 | >0.090 | >0.12 | 0.61 |
| EX12 | >0.080 | >0.10 | 0.51 |
| EX13 | >0.091 | >0.15 | 0.74 |
| EX14 | >0.099 | >0.12 | 0.58 |
| EX15 | >0.099 | >0.12 | 0.61 |
| EX16 | >0.096 | >0.13 | 0.64 |

Melt Behavior:
Melt behavior of the dot compositions was measured using an ARES G2 rheometer.

Complex viscosity (η*), in Pa·s (pascal-seconds) at various temperatures was recorded in Table 5.

TABLE 5
Melt Behavior Test Results

| | η* at | η* at | η* at | η* at | η* at | η* at | η* at | η* at | η* at |
|---|---|---|---|---|---|---|---|---|---|
| | 80 C. | 96 C. | 100 C. | 125 C. | 140 C. | 150 C. | 160 C. | 175 C. | 200 C. |
| CE1 | ND | 1 × 10⁶ | 1 × 10⁴ | 4 × 10¹ | 2 × 10¹ | 1 × 10¹ | ND | ND | ND |
| EX1 | ND | ND | 6 × 10⁵ | 7 × 10¹ | ND | ND | ND | ND | ND |
| CE2 | ND | ND | ND | ND | 1 × 10⁵ | 3 × 10³ | 3 × 10⁰ | ND | ND |
| EX2 | ND | ND | 1 × 10⁵ | 9 × 10³ | 3 × 10³ | 2 × 10³ | 1 × 10³ | 7 × 10² | 3 × 10² |
| EX3 | ND | ND | 9 × 10³ | 5 × 10³ | 3.5 × 10³ | ND | ND | ND | ND |
| EX4 | | | | | | | | | |
| CE3 | 1 × 10¹ | ND | ND | ND | ND | ND | ND | ND | ND |
| CE4 | | | | | | | | | |
| EX7 | ND | ND | 1 × 10⁵ | 1 × 10⁴ | 3 × 10³ | 3 × 10³ | 7 × 10² | 3.5 × 10² | 1.5 × 10² |
| EX9 | ND | ND | nd | 1.5 × 10⁵ | 6 × 10⁴ | 3.5 × 10⁴ | 2 × 10⁴ | 1 × 10⁴ | 4 × 10³ |
| CE5 | 4 × 10⁶ | ND | 4 × 10⁴ | 3 × 10⁴ | 2 × 10⁴ | 1 × 10⁴ | 1 × 10⁴ | 8 × 10³ | 5 × 10³ |
| CE6 | 7 × 10⁶ | ND | 4 × 10⁴ | 3 × 10⁴ | 2 × 10⁴ | 1 × 10⁴ | 1 × 10⁴ | 8 × 10³ | 5 × 10³ |
| CE7 | 1 × 10⁷ | ND | 4 × 10⁴ | 3 × 10⁴ | 2 × 10⁴ | 1 × 10⁴ | 1 × 10⁴ | 8 × 10³ | 5 × 10³ |
| CE8 | ND | ND | 4 × 10⁴ | 3 × 10⁴ | 2 × 10⁴ | 1 × 10⁴ | 1 × 10⁴ | 8 × 10³ | 5 × 10³ |
| CE9 | 9 × 10⁶ | ND | 4 × 10⁴ | 3 × 10⁴ | 2 × 10⁴ | 1 × 10⁴ | 1 × 10⁴ | 8 × 10³ | 5 × 10³ |
| CE10 | ND | ND | 5 × 10⁴ | 3 × 10⁴ | 2 × 10⁴ | 1 × 10⁴ | 1 × 10⁴ | 8 × 10³ | 5 × 10³ |
| EX11 | 2 × 10⁶ | ND | 2 × 10⁵ | 1 × 10⁵ | 7 × 10⁴ | 6 × 10⁴ | 5 × 10⁴ | 4 × 10⁴ | 2 × 10⁴ |
| EX12 | 2 × 10⁶ | ND | 2 × 10⁵ | 9 × 10⁴ | 7 × 10⁴ | 4 × 10⁴ | 3 × 10⁴ | 2 × 10⁴ | 1 × 10⁴ |
| EX13 | 2 × 10⁶ | ND | 2 × 10⁵ | 1 × 10⁵ | 7 × 10⁴ | 6 × 10⁴ | 5 × 10⁴ | 4 × 10⁴ | 2 × 10⁴ |
| EX14 | 2 × 10⁶ | ND | 2 × 10⁵ | 1 × 10⁵ | 7 × 10⁴ | 6 × 10⁴ | 5 × 10⁴ | 4 × 10⁴ | 2 × 10⁴ |
| EX15 | 2 × 10⁶ | ND | 2 × 10⁵ | 1 × 10⁵ | 7 × 10⁴ | 6 × 10⁴ | 5 × 10⁴ | 4 × 10⁴ | 2 × 10⁴ |
| EX16 | 2 × 10⁶ | ND | 2 × 10⁵ | 1 × 10⁵ | 7 × 10⁴ | 6 × 10⁴ | 5 × 10⁴ | 4 × 10⁴ | 2 × 10⁴ |

ND = Not Determined

### Crystallinity:

Crystallinity was determined in selected compositions using a Discovery 2500 Differential Scanning calorimeter (DSC2A-00883/RCS) system utilizing a heat-cool-heat method in temperature modulated mode. Percent crystallinity was estimated from the measured heats of fusion of the compositions, ΔH_{f,DSC} divided by the product of the heat of fusion of pure crystalline polymer ΔH_{f,P} (e.g., 91 J/g for PLA) and the mass fraction of polymer in the composition, X_{P}. Results are recorded in Table 6.

$$\% crystallinity \approx Δ {H}_{f , DSC} / ( Δ {H}_{f , P} {x}_{P} )$$

TABLE 6
Crystallinity Test Results

| | | | | | | | | | Crystalline | Crystalline |
|---|---|---|---|---|---|---|---|---|---|---|
| | | | | | | | | | PLA relative | PBAT relative |
| | | | | | | wt % | wt % | total wt % | to total | to total |
| | | | | ΔH_{f, PLA} | ΔH_{f, PBAT} | crystal | crystal | crystallized | PLA in | PBAT in |
| ID | X_{P} | X_{PLA} | X_{PBAT} | (J/g) | (J/g) | PLA | PBAT | polymer | sample | sample |
| EX2 | 0.60 | 0.60 | 0 | 34 | 0 | 37.4 | 0 | 37 | 62 | 0 |
| EX7 | 0.90 | 0.90 | 0 | 4 | 0 | 4.4 | 0 | 4 | 5 | 0 |
| CE5 | 0.90 | 0 | 0.36 | 0 | 11.2 | 0 | 10 | 10 | 0 | 27 |
| CE6 | 0.95 | 0 | 0.38 | 0 | 11.8 | 0 | 10 | 10 | 0 | 27 |
| CE7 | 0.90 | 0 | 0.36 | 0 | 11.8 | 0 | 10 | 10 | 0 | 29 |
| CE8 | 0.95 | 0 | 0.38 | 0 | 11.3 | 0 | 10 | 10 | 0 | 26 |
| CE9 | 0.90 | 0 | 0.36 | 0 | 13.2 | 0 | 12 | 12 | 0 | 32 |
| CE10 | 0.95 | 0 | 0.38 | 0 | 12.3 | 0 | 11 | 11 | 0 | 28 |
| EX11 | 0.90 | 0.30 | 0.37 | 4.4 | 0 | 4.8 | 0 | 5 | 16 | 0 |
| EX12 | 0.95 | 0.32 | 0.39 | 3.9 | 0 | 4.3 | 0 | 4 | 13 | 0 |
| EX13 | 0.90 | 0.30 | 0.37 | 4.7 | 0 | 5.2 | 0 | 5 | 17 | 0 |
| EX14 | 0.95 | 0.32 | 0.39 | 6.4 | 0 | 7.0 | 0 | 7 | 22 | 0 |
| EX15 | 0.90 | 0.30 | 0.37 | 5.6 | 0 | 6.2 | 0 | 6 | 20 | 0 |
| EX16 | 0.95 | 0.32 | 0.39 | 4.4 | 0 | 4.8 | 0 | 5 | 15 | 0 |

Ecoflex Batch AB1 is 40% PBAT (60% CaCO₃); Ecovio F2341 is 25% filler (CaCO₃ and talc) and 75% polymer, in a ratio of 55% PBAT/45% PLA. For the crystalline weight % calculations, the theoretical 100% crystalline enthalpies are 91 J/g and 114 J/g for PLA and PBAT respectively.

### Biodegradability Test:

### Examples 22-25 (EX22-EX25)

Samples were made with materials and adhesive weight parameters as defined in Table 7 on Substrate 4 printed with the composition described in EX7, except for the control (3M Scrub Dots obtained from 3M Company, St. Paul, MN. USA), which was made with approximately 15 mm thick cellulose sponge laminated to non-biodegradable materials. All samples and the control were rinsed several times to remove preservative from the cellulose prior to starting the test.

TABLE 7
Sample Material and Coating Weight

| | | Adh Coating wt | |
|---|---|---|---|
| | Adhesive | (g/m2) | Sponge type |
| EX22 | HY-288 | 172 | sponge cloth |
| EX23 | HY-288 | 256 | sponge cloth |
| EX24 | HY-288 | 366 | 15 mm thick cellulose |
| EX25 | 3M 3789 | 248 | 15 mm thick cellulose |

ISO 20200 was used to measure the degree of disintegration with the following modifications: C/N ratios and pH of the compost inoculum were not measured; volatile solids were not measured before or after the test; a vented oven was used in place of a recirculating oven; pine shavings (0-3 mm) were used in place of sawdust; water was added periodically to compensate for water vapor escaping from containers; and only one replicate for each material ID was tested. Composting was carried out in five 5.0-liter containers with aeration as described in ISO-20200 section 6. Ripe compost inoculum was obtained from SET Inc., located in Rosemount, MN, in August 2020 and stored at 40° F. until the test start date. Upon completion of the test and after drying for ten days at 58° C. to obtain equilibrium remaining dry mass, each container was weighed and compared to the original weights to determine the solids lost. The material was then sieved using screens with 9.5 mm, 4.75 mm, and 2 mm openings. The mass captured was dried for 18 hours at 105° C. to remove any water content. The mass captured by each sieve was recorded, and the degree of disintegration was calculated as the amount of material that passed through a given sieve size divided by the original sample mass. Samples were observed to decompose as much as 99% (as measured on a 9.5 mm sieve) over the 8-week test period (see Table 8).

TABLE 8
Disintegration Test Results

| | sample | initial | final | weight | weight | ≥9.5 mm | ≥4.75 mm | ≥2 mm | | | |
|---|---|---|---|---|---|---|---|---|---|---|---|
| Construction | added | total | weight | loss | loss | sieve | sieve | sieve | <9.5 mm | <4.75 mm | <2 mm |
| ID | (g) | wt (g) | (g) | (g) | (%) | (g) | (g) | (g) | (%) | (%) | (%) |
| Control | 14.02 | 511 | 234 | 277 | 54 | 5.492 | 0 | 0 | 61 | 61 | 61 |
| EX22 | 13.96 | 513 | 234 | 279 | 54 | 4.284 | 0.898 | 0.212 | 69 | 63 | 61 |
| EX23 | 14.32 | 515 | 232 | 283 | 55 | 6.517 | 0 | 0.097 | 54 | 54 | 54 |
| EX24 | 14.15 | 511 | 230 | 281 | 55 | 1.341 | 1.956 | 1.067 | 0 | 77 | 69 |
| EX25 | 13.96 | 509 | 230 | 279 | 55 | 0.196 | 0.968 | 2.116 | 99 | 92 | 77 |

### Article Cleaning Efficacy Test:

The article cleaning efficacy test was performed in a generally similar manner as that described in U.S. Pat. No. 5,626,512 (Palaikis et al). A stainless steel disk was coated with a food soil mixture made up of 120 grams milk, 60 grams cheddar cheese, 120 grams hamburger, 120 grams tomato juice, 120 grams cherry juice, 20 grams flour, and 100 granulated sugar, and one egg. The coated panel was baked in an oven at 230° C. for one hour. The above coating and curing process was repeated three times to achieve uniform coat on the disk, then the disk was attached to the lower turntable of a Schiefer Abrasion Tester modified to accommodate the disc. A 2.26 kg (5 lb.) head weight was used as the applied force. A sample was saturated with water, centered and fastened against the upper turntable of the test machine and tested under wet conditions by lubricating the disc with water at a rate of 1 drop/second. The test was stopped when the coated disk was scoured clean, or at 5500 cycles, whichever came first. Three replicates for each sample were tested and the number of cycles to clean each panel was recorded as an average (Table 9). The Control used was 3M Scrub Dots obtained from 3M Company, St. Paul, MN. USA.

TABLE 9
Cleaning Efficacy Test Results

| Control | EX7 | EX8 |
|---|---|---|
| 5500 | 3587 | 879 |

As can be seen in Table 9, Examples 7 and 8 outperformed the control.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A biobased homogeneous composition comprising:
a biobased polymer; and
a biobased wax, wherein the biobased wax comprises less than about 20% of the biobased homogenous composition, and
wherein the biobased composition has a modulus of elasticity of at least about 0.5 GPa and a strain energy density of at least about 0.1 mJ/mm³.

2. The biobased homogeneous composition of claim 1, wherein the biobased polymer is selected from one of: polylactic acid, polybutylene succinate, polybutylene adipate terephthalate, and mixtures thereof.

3. The biobased homogeneous composition of claim 1, wherein the biobased homogeneous composition is substantially free of tackifier.

4. The biobased homogeneous composition of claim 1, wherein the biobased polymer has a Shore D durometer of at least about 50 when measured according to ASTM D2240-15.

5. The biobased homogeneous composition of claim 1, wherein the biobased homogeneous composition has a wet coefficient of friction of about 0.40 or less.

6. The biobased homogeneous composition of claim 1, wherein the biobased homogeneous composition has a percent crystallinity of about 50% or less.

7. The biobased homogeneous composition of claim 1, wherein the complex viscosity of the biobased homogeneous composition at 100° C. is at least about 5×10¹ Pa·s and at 175° C. is less than about 1×10⁵ Pa·s.

8. A scouring article comprising:
a nonwoven substrate; and
a biobased composition affixed onto the nonwoven substrate, the biobased composition comprising:
a biobased polymer; and
a biobased wax, wherein the biobased wax comprises less than about 20% of the biobased composition, and
wherein the biobased composition has a modulus of elasticity of at least about 0.5 GPa and a strain energy density of at least about 0.1 mJ/mm³ when measured according to ASTM D790-17,
wherein a composition of the nonwoven substrate is substantially different from the biobased composition.

9. The scouring article of claim 8, wherein the biobased composition is affixed onto the nonwoven substrate by a hot melt coating process.

10. The scouring article of claim 8, wherein the biobased composition is affixed onto the nonwoven substrate in a plurality of discrete segments.

11. The scouring article of claim 10, wherein the biobased composition is affixed in a pattern.

12. The scouring article of claim 8, wherein the substrate is affixed to a cellulose or foam sponge.

13. The scouring article of claim 8, wherein the scouring article has a degree of disintegration of at least about 50% after 8 weeks when measured according to ISO 20200:2015 for 8 weeks.

14. The scouring article of claim 8, wherein the biobased polymer is selected from one of: polylactic acid, polybutylene succinate, polybutylene adipate terephthalate, and mixtures thereof.

15. The scouring article of claim 8, wherein the biobased composition is substantially free of tackifier.

16. The scouring article of claim 8, wherein the biobased polymer has a Shore D durometer of at least about 50 when measured according to ASTM D2240-15.

17. The scouring article of claim 8, wherein the biobased composition has a wet coefficient of friction of about 0.50 or less.

18. The scouring article of claim 8, wherein the biobased composition has a percent crystallinity of about 50% or less.

19. The scouring article of claim 8, wherein the complex viscosity of the biobased composition at 100° C. is at least about 5×10¹ Pa·s and at 175° C. is less than about 1×10⁵ Pa·s.

20. The scouring article of claim 8, wherein the biobased wax is one of soybean oil, castor oil, and ethylene bis-stearamide.
